(19) United States
(12) Patent Application Publication
(10) Pub. No.: US 2002/0139741 A1
(43) Pub. Date: Oct. 3, 2002

(54) Integral gasketed filtration cassette article and method of making the same

(76) Inventor: Henry Kopf III, Cary, NC (US)

Correspondence Address: Steven J. Hultquist, Intellectual Property/Technology Law, P. O. Box 14329, Research Triangle Park, NC, 27709, US

(21) Appl. No.: 09/818,823

(22) Filed: Mar. 27, 2001

(51) Int. Cl. B01D 25/12

(52) U.S. Cl. 210/224; 210/231

(57) ABSTRACT

An integral gasketed filtration cassette structure of a type comprising a filtration cassette fully or partially overcoated by a gasket layer, forming a fluid-tight seal between the filtration cassette and the filtration cassette holder to which the filtration cassette is to be affixed. The filtration cassette comprises filter sheets arranged in a multilaminate, peripherally bonded array, wherein the filter sheets alternate with permeate and retentate sheets. The gasket layer comprises an elastomeric material with suitable hardness and temperature resistance for sealing, such as silicone, ethylenepropylenedienemonomer (EPDM), viton, polyurethane, polypropylene, polyethylene, polyvinylchloride, polyester, epoxy, ethylvinylacetate, bunnas, and styrene butadiene. The filtration cassettes and filter of the invention may be advantageously employed for dewatering of aqueous biomass suspensions, desalting of proteins, removal of secreted metabolites from cellular suspensions, and the like.

### BACKGROUND OF THE INVENTION

1. Field of the Invention

This invention relates generally to an integral gasketed filtration cassette structure, as well as method of making such structure. The integral gasketed filtration cassette structure comprises a fluid filtration cassette overcoated by at least one thin gasket layer, wherein said thin gasket layer provides a fluid-tight seal between the filtration cassette and the cassette holder to which the filtration cassette is to be affixed. The invention further relates generally to cross-flow filters comprising a multiplicity of stacked filtration cassette structures of such type.

2. Description of the Related Art

Stacked plate cross-flow filters are utilized in a variety of solids-liquid separation operations, including the dewatering of solids-liquid suspensions such as aqueous biomass suspensions, the desalting of proteins, and the removal of secreted metabolites from cellular cultures.

In such systems, the stacked plates making up the cross-flow filter are typically mounted in a unitary frame structure whereby the respective plates are retained in alignment with one another, in a so-called “plate and frame” construction.

The plate and frame filter typically utilizes a unitary liquid feed conduit provided with openings at spaced intervals along its length and extending through the stacked plates as a means to introduce influent solids-containing liquid into the flow channels defined between adjacent plates in the stacked plate assembly. The flow channels in the plate and frame filter contain filter elements, such as disposable filter paper sheets or polymeric membranes, with which the solids-containing liquid is contacted and through which solids-depleted liquid passes. A unitary liquid withdrawal conduit featuring openings at spaced intervals along its length correspondingly extends through the stacked plates, in liquid flow communication with the respective flow channels of the stacked plate assembly, and conveys solids-depleted liquid out of the filter system.

U.S. Pat. No. 5,593,580 and U.S. Pat. No. 5,868,930 both disclose filtration cassettes of a generally rectangular shape with planar upper and bottom surfaces. Each filtration cassette comprises filter sheets arranged in a multilaminate, peripherally bonded array, wherein the filter sheets alternate with permeate and retentate sheets. Such filtration cassette may be mounted onto a base including a mounting plate and an upper end plate. The mounting plate has vertically upwardly extending rods at four corners, which corresponds to openings on the filtration cassette. Between the filtration cassette and the mounting plate is a compressible gasket sheet member. Such compressible gasket sheet member functions as a seal the surface of the filtration cassette that is in contact with the mounting plate. Similarly, there is a compressible gasket sheet member between the filtration cassette and the opposite end plate for sealing the surface of the filtration cassette that is in contact with the opposite end plate.

Such compressible gasket sheets, however, is vulnerable to misalignment during installation. They may also slide out of place during operation after installation has been completed and cause leaking between said filtration cassette and the mounting plate/end plate. Moreover, such compressible retentate gasket may “cold flow”, generating an uneven edge that blocks the entry-exit port(s) for fluids and/or leaves a leaking gap.

O-rings have generally been used for sealing purposes. However, they are not suitable for the purpose of effectively sealing the surfaces of the filtration cassette disclosed in the U.S. Pat. No. 5,593,580 and the U.S. Pat. No. 5,868,930, because o-ring seals require concave groves for receiving the o-rings. Such groves always leave a gap easy to accumulate debris but hard to clean. Moreover, o-rings, like the compressible retentate sheets mentioned hereinabove, are vulnerable to misalignments during installation, which cause leaking problems subsequently.

Accordingly, it would be a significant advance in the art to provide an improved filtration article of a type which provides more effective and reliable sealing means for the filter cassettes disclosed in prior U.S. Pat. Nos. 5,593,580 and 5,868,930.

It is another object of the invention to provide a stacked filter comprising a stack of improved filtration articles of such type.

It is another object of the invention to provide a method of making such improved filtration article, in a simple, efficient, and economical manner.

Other objects and advantages of the invention will be more fully apparent from the ensuing disclosure and appended claims.

### SUMMARY OF THE INVENTION

The present invention relates generally to integral gasketed filtration cassette structures, comprising a filtration cassette having membrane filter sheets arranged in a multilaminate, peripherally bonded array and in alternation with permeate sheets and retentive sheets, wherein said filtration cassette is overcoated by at least one thin gasket layer comprising an elastomeric material.

In another aspect, the present invention relates to cross-flow stacked filters comprising a multiplicity of gasketed filtration cassettes of the general type described in the preceding paragraph, as well as to a method of making such filtration cassettes.

In one particular aspect, the present invention relates to an integral gasketed filtration cassette structure, comprising:

(a) a filtration cassette comprising a multilaminate array of sheet members of generally rectangular and generally planar shape with main top and bottom surfaces, wherein the sheet members include in sequence in the array a terminal end plate, a first retentate sheet, a first filter sheet, a permeate sheet, a second filter sheet, and a second retentate sheet, and a second terminal end plate, wherein each of the sheet members in the array has at least one inlet basin opening at one end thereof, and at least one outlet basin opening at an opposite end thereof, with at least one permeate passage opening:

each of the first and second retentate sheets having at least one channel opening therein, wherein each channel opening extends longitudinally between the inlet and outlet basin openings of the sheets in the array and is open through the entire thickness of the retentate sheet, and with each of the first and second retentate sheets being bonded to an adjacent filter sheet about peripheral end and side portions thereof, with their basin openings and permeate passage openings in register with one another, and arranged to permit flow of filtrate through the channel openings of the retentate sheet between the inlet and outlet basin openings to permit permeate flow through the filter sheet to the permeate sheet to the permeate passage openings;

wherein each of the filter sheets is secured at its peripheral portions on a face thereof opposite the retentate sheet, to the permeate sheet;

(b) at least one thin gasket layer bonded to a surface of said filtration cassette and forming an integral unitary structure with said filtration cassette, wherein said thin gasket layer comprises an elastomeric material for forming a fluid-tight seal between the filtration cassette and an adjacent structure when engaged therewith.

Such thin gasket layer preferably comprises an elastomeric material having hardness in the range from about 30 to about 80 durometers, more preferably in the range from about 40 to about 60 durometers.

The term “thin”, as used herein, is defined as having a thickness of not more than 0.3 inch. Preferably, the thin gasket layer in the present invention has a thickness in the range from about 0.01 inch to about 0.1 inch, and more preferably in the range from about 0.02 inch to about 0.06 inch.

Because the filtration cassette structure of the present invention operates at various temperatures, it is preferred that the thin gasket layer has comparable temperature resistance, at least within the temperature range from about 0° C. to about 70° C. More preferably, such thin gasket layer retains its temperature resistance within a wider temperature range from about −5° C. to about 125° C., and most preferable within the temperature range from about −10° C. to about 150° C.

Any suitable elastomeric material may be employed for making such thin gasket layer of the present invention, and a person ordinarily skilled in the art can readily determine and choose the types of materials to be used according to specific operational conditions and requirements. Examples of useful elastomeric materials are silicone, ethylenepropylenedienemonomer (EPDM), viton, polyurethane, polypropylene, polyethylene, polyvinylchloride, polyester, epoxy, ethylvinylacetate, bunnas, styrene butadiene, etc. Silicone rubber is one of the preferred elastomeric materials due to its low costs and industrial availability.

The thin gasket layer may overcoat the filtration cassette in any suitable form or manner, so long as to form an integral whole with such filtration cassette for providing reliable sealing substantially invulnerable to misalignments as well as for reducing installation costs of such.

In one preferred embodiment of the present invention, the thin gasket layer fully encapsulates the filtration cassettes, on all surfaces of said cassettes. Such embodiment provides maximum sealing surface for effective prevention of fluid leakage therethrough. Moreover, such embodiment provides more contacting areas between the thin gasket layer and the filtration cassettes to which it is bonded to, and therefore strengthens the bond between the gasket layer an the filtration cassettes, further reducing the risk of misalignment of said gasket layer during installation or operation.

In an alternative embodiment of the present invention, the integral gasketed filtration cassette structure comprises a filtration cassette partially covered by one or more thin gasket layers. For example, such integral gasketed filtration cassette structure may comprise a filtration cassette with only its top and bottom surfaces overcoated by two thin gasket layers, or a filtration cassette with only parts of its top and bottom surfaces (such as regions around the inlet/outlet basins and permeate passage openings, where the filtrate fluid is likely to leak through) overcoated by discrete thin gasket layers. The advantage of this embodiment of partial cover is that less gasket is required, therefore reducing overall manufacturing costs.

The thin gasket layer can be applied/bonded onto the surface of the filtration cassette by any suitable method, depending on specific physical and chemical characteristics of the gasket materials used. Useful methods include, but are not limited to, molding, adhering, welding, spray coating, dipping, painting, etc.

Specifically, molding of gasket material around the filtration cassette, to therefore form one or more thin gasket layers that substantially encapsulate the filtration cassette, is one of the preferred methods, because of its procedural simplicity that makes it particularly suitable for mass production. Alternatively, the gasket layers can be separately manufactured and subsequently bonded to the surface of the filtration cassettes by either adhering or welding. Urethane, epoxy, cyanoacrylate, and silicone adhesives are particularly effective for adhering such gasket layers to the filtration cassettes. Heat sealing, radio-frequency welding, ultra-sonic welding, and impulse welding can also be used for bonding the pre-manufactured gasket layers to the filtration cassettes.

Another aspect of the present invention relates to a stacked cassette cross-flow filter comprising a stacked assembly of integral gasketed filtration cassette structures, each structure comprising:

(a) a filtration cassette comprising a multilaminate array of sheet members of generally rectangular and generally planar shape with main top and bottom surfaces, wherein the sheet members include in sequence in the array a first retentate sheet, a first filter sheet, a permeate sheet, and a second filter sheet, and a second retentate sheet, wherein each of the sheet members in the array has at least one inlet basin opening at one end thereof, and at least one outlet basin opening at an opposite end thereof, with at least one permeate passage opening:

each of the first and second retentate sheets having at least one channel opening therein, wherein each channel opening extends longitudinally between the inlet and outlet basin openings of the sheets in the array and is open through the entire thickness of the retentate sheet, and with each of the first and second retentate sheets being bonded to an adjacent filter sheet about peripheral end and side portions thereof, with their basin openings and permeate passage openings in register with one another, and arranged to permit flow of filtrate through the channel openings of the retentate sheet between the inlet and outlet basin openings to permit permeate flow through the filter sheet to the permeate sheet to the permeate passage openings;

wherein each of the filter sheets is secured at its peripheral portions on a face thereof opposite the retentate sheet, to the permeate sheet;

(b) at least one thin gasket layer bonded to a surface of said filtration cassette and forming an integral unitary structure with said filtration cassette, wherein said thin gasket layer comprises an elastomeric material for forming a fluid-tight seal between adjacent filtration cassettes and between the filtration cassette and an adjacent structure when engaged therewith.

Still another aspect of the present invention relates to a filter assembly, which comprises:

(a) a first end plate;

(b) a second end plate;

(c) one or more integral filtration cassette structures as of claim 1 secured between the first and the second end plate, wherein the thin gasket layers of said integral filtration cassette structures form fluid-tight sealing surfaces between said filtration cassettes and said first and second end plates as well as between adjacent filtration cassette structures.

Other aspects and features of the present invention will be more fully apparent from the ensuing disclosure and appended claims.

### BRIEF DESCRIPTION OF THE DRAWINGS

FIG. 1 is a perspective view of an integral gasketed filtration cassette structure comprising a filtration cassette fully encapsulated by a gasket layer, according to one embodiment of the present invention.

FIG. 1A is a perspective view of another integral gasketed filtration cassette structure comprising a filtration cassette partially covered by two gasket layer on two planar surfaces, according to another embodiment of the present invention.

FIG. 2 is an exploded perspective view of a filtration cassette according to one embodiment of the present invention.

FIG. 3 is a cross-sectional view of a gasketed filtration cassette structure comprising the filtration cassette of FIG. 2 fully encapsulated by a gasket layer.

FIG. 3A is a cross-sectional view of a gasketed filtration cassette structure comprising the filtration cassette of FIG. 2 partially covered by two gasket layers on its top and bottom surfaces.

FIG. 4 is an exploded view of a filter assembly comprising an integral filtration cassette structure according to one embodiment of the present invention between two end plates.

FIG. 5 is a perspective elevation view of the filter assembly of FIG. 4.

FIG. 6 is a top plan view of a portion of a filtration cassette according to one embodiment of the present invention.

FIG. 7 is a top plan view of a portion of a filtration cassette according to another embodiment of the invention.

FIG. 8 is a top plan view of a filter sheet of a type which may be usefully employed in the cassette of FIG. 2.

FIG. 9 is a top plan view of a retentive sheet of a type which may be usefully employed in the cassette of FIG. 2.

FIG. 9A is a top plan view of a portion of a retentate sheet according to another embodiment of the invention, featuring four quadrilateral-shaped basins.

FIG. 10 is a top plan view of a compressible end gasket of a type which may be usefully employed in the cassette of FIG. 2.

FIG. 10A is a top plan view of a compressible end gasket according to another embodiment of the invention, featuring four quadrilateral-shaped basins.

FIG. 11 is a top plan view of a formaminous permeate sheet of a type which may be usefully employed in the cassette of FIG. 2.

FIG. 12 is a top plan view of a portion of a filtration cassette, composed of sheet members P/F/P featuring two quadrilateral-shaped basins after the first die cut.

FIG. 12A is a top plan view of a portion of a filtration cassette, composed of sheet members P/F/P according to another embodiment of the invention, featuring four quadrilateral-shaped basins after the first die cut.

### DETAILED DESCRIPTION OF THE INVENTION, AND PREFERRED EMBODIMENTS THEREOF

The disclosures of U.S. Pat. Nos. 5,593,580 and 5,868,930 are hereby incorporated for all purposes, in their entirety.

The integral filtration cassette structure of the present invention is adapted to be used in combination with filtration cassette holder comprising at least two end plates for holding said filtration cassette structure, with the improvement of having an integral filtration cassette/gasket structure substantially invulnerable to misalignment or leakage caused thereby.

Specifically, such filtration cassette structure comprises a filtration cassette as disclosed in U.S. Pat. Nos. 5,593,580 and 5,868,930, fully or partially encapsulated by one or more thin gasket layers. Such thin gasket layers are bonded onto surface of the filtration cassette in a secure manner so as to form an integral whole therewith and to provide a fluid-tight seal between the filtration cassette and the filtration cassette holder. Such integral filtration cassette/gasket structure reduces the risk of misalignment between the gasket and the filtration cassette, which is the major cause of leakage in a filter assembly comprising separate filtration cassette and gasket layers.

The filter cassette of the present invention comprises a base sequence of retentate sheet (R), filter sheet (F), permeate sheet (P), filter sheet (F), and retentate sheet (R), which may be repeated in the sequence of sheets in the filter cassette as desired, e.g., in a repetitive sequence of retentate sheet (R), filter sheet (F), permeate sheet (P), filter sheet (F), retentate sheet (R), filter sheet (F), permeate sheet (P), filter sheet (F), retentate sheet (R), filter sheet (F), retentate sheet (R). Thus, the filter cassette of a desired total mass transfer area is readily formed from a stack of the repetitive sequences. In all repetitive sequences, except for a single unit sequence, the following relationship is observed: where X is the number of filter sheets, 0.5X-1 is the number of interior retentate sheets, and 0.5X is the number of permeate sheets, with two outer retentate sheets being provided at the outer extremities of the stacked sheet array.

The filter sheets, and the retentate and permeate sheets employed therewith, may be formed of any suitable materials of construction, including, for example, polymers, such as polypropylene, polyethylene, polysulfone, polyethersulfone, polyetherimide, polyimide, polyvinylchloride, polyester, etc.; nylon, silicone, urethane, regenerated cellulose, polycarbonate, cellulose acetate, cellulose triacetate, cellulose nitrate, mixed esters of cellulose, etc.; ceramics, e.g., oxides of silicon, zirconium, and/or aluminum; metals such as stainless steel; polymeric fluorocarbons such as polytetrafluoroethylene; and compatible alloys, mixtures and composites of such materials.

Preferably, the filter sheets and the retentate and permeate sheets are made of materials which are adapted to accommodate high temperatures and chemical sterilants, so that the interior surfaces of the filter may be steam sterilized and/or chemically sanitized for regeneration and reuse, as “steam-in-place” and/or “sterilizable in situ” structures, respectively. Steam sterilization typically may be carried out at temperatures on the order of from about 121° C. to about 130° C., at steam pressure of 15-30 psi, and at a sterilization exposure time typically on the order of from about 15 minutes to about 2 hours, or even longer. Alternatively, the entire cassette structure may be formed of materials which render the cassette article disposable in character.

The gasket layers over-coating the filtration cassette desirably comprise elastomeric materials of sufficient temperature and chemical resistances to accommodate high temperatures and chemical sterilants as mentioned hereinabove. Preferably, such elastomeric materials have temperature resistance at least within the temperature range from about 0° C. to about 70° C., and more desirably within the temperature range from about −10° C. to about 150° C.

In order to form a fluid-tight sealing surface between the filtration cassette and the end plates of the cassette holder to which the filtration cassette is affixed to, the gasket layer must comprises elastomeric materials with suitable hardness. Materials too hard have poor performance as sealing materials, while materials too soft are likely to “cold flow”, which causes an unevenness on the sealing surface, or more severely, blocks the entry/exit ports of fluid. Therefore, elastomeric materials with hardness within the range from about 30 to about 80 durometers are preferred, and more preferably, such materials have hardness within the range from about 40 to about 60 durometers.

If the fluid filtration cassette structures are to be used in food or beverage-related applications, such elastomeric materials forming the gasket layers therein also should have minimum toxicity and be able to pass FDA standards for materials used in food and beverage applications. If the fluid filtration cassette structures are used in pharmaceutical and biotechnological areas, the elastomeric materials forming the gasket layers therein also should meet the standards for extratables and toxicity required by United States Pharmacopeia Class VI certification.

The end plates used with the cassette articles of the invention to form a unitary filter assembly may be formed of any suitable materials of construction, including, for example, stainless steel or other suitable metal, or polymers such as polypropylene, polysulfone, and polyetherimide.

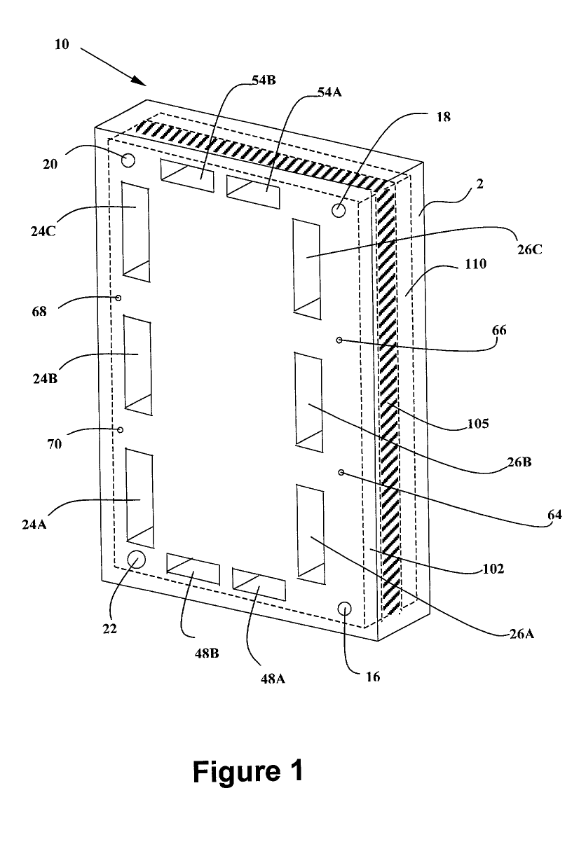

FIG. 1 is a perspective view of an integral gasketed filtration cassette structure 10 comprising a filtration cassette (as shown by dashed lines in FIG. 1) fully encapsulated by a gasket layer 2 (as shown by full lines in FIG. 1) according to one embodiment of the present invention.

The filtration cassette comprises two compressible sheets 102 and 110 and multiple filter sheets and formaminous permeate sheets seen as structure 105 in FIG. 1. The filtration cassette are provided with openings 16, 18, 20, and 22, respectively, which extend through the cassette and are employed for mounting of the cassette on rods of diameter closely approximate but slightly smaller than the respective openings. In this respect, it is to be noted that opening 22 is of larger size (diameter) than the remaining openings 16, 18, and 20. The purpose of such disparity in opening size is to provide a “keying” feature whereby the proper alignment of the plate is secured, since only opening 22 will fit over a large-sized rod of corresponding diameter, whereas openings 16, 18, and 20 will not accommodate passage over such a large-sized rod. The filtration cassette is also provided, optionally, at its respective side margins with openings 64, 66, 68, and 70 which are smaller than openings 16, 18, 20, and 22.

The filtration cassette also is provided at its respective side margins, at the mid-section of the longitudinally extending cassette, with openings 24A, B, C, D, E and 26A, B, C, D, E extending through the cassette. These openings may be employed for egress of permeate produced in the filtration operation when the cassette is deployed in the stacked cassette filter assembly illustrated, and/or otherwise for accommodating ingress/egress of a selected fluid, such as steam or other sterilant fluid for effecting cleaning and regeneration of the filter, or a secondary fluid for mass transfer contacting with a primary fluid passage through the filter.

The gasket layer 2, which may or may not be transparent, completely encapsulates the filtration cassette and forms an integral structure with such filtration cassette. It is therefore unlikely for such gasket layer 2 to be moved out of place, and no alignment is required when such gasketed filtration cassette structure is installed.

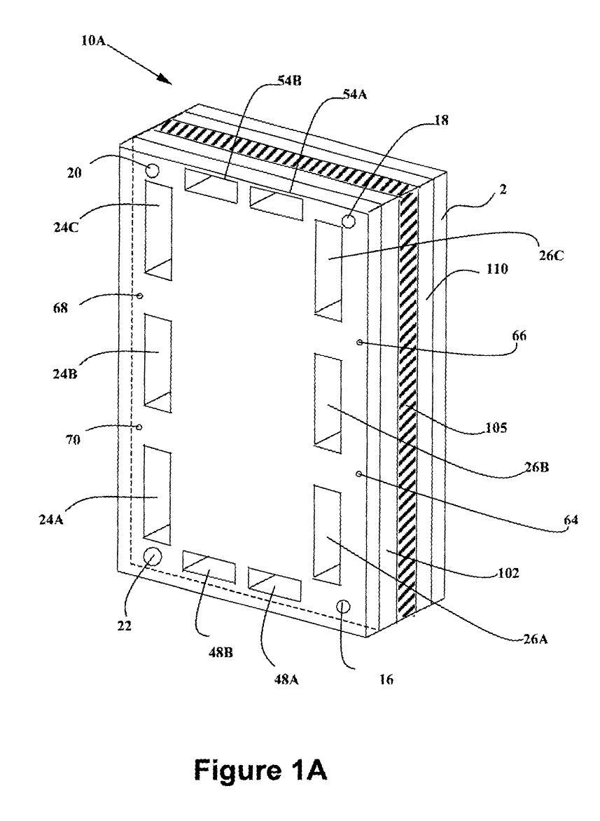

FIG. 1A is a perspective view of another integral gasketed filtration cassette structure 10A comprising the filtration cassette of FIG. 1 overcoated by two gasket layers 2 only on its two planar surfaces (i.e. the front and rear surfaces as shown in FIG. 2) according to one embodiment of the present invention. The side surfaces of such filtration cassette are not covered by the gasket layers.

The gasket layers as in FIGS. 1 and 1A may comprises any elastomeric materials, such as silicone, ethylenepropylenedienemonomer (EPDM), viton, polyurethane, polypropylene, polyethylene, polyvinylchloride, polyester, epoxy, ethylvinylacetate, bunnas, and styrene butadiene. They can be bonded to the filtration cassette by any means, including but not limited to molding, adhering, welding, and spray coating.

In a preferred embodiment of the present invention, the gasket layer comprises silicone material being molded to the outer surface of the filtration cassette. In order to enhance the bonding strength between such molded silicone gasket layer and the surface of the filtration cassette, an organic solvent is used to solve the raw silicone before molding. Preferably, such organic solvent is capable of partially solving the surface of the filtration cassette, which may be made of polycarbonate, silicone, urethane, polysulfone, polyethersulfone, polyetherimide, etc. Therefore, when the silicone paste is molded around the filtration cassette, the organic solvent partially solves the surface of the filtration cassette, and the silicone paste and the surface cassette are integrally molded together after such organic solvent is evaporated. Suitable organic solvents include, but are not limited to short chain alkanes, chlorinated hydrocarbons, aromatic solvents, and alcohols.

FIG. 2 is an exploded perspective view of a typical filtration cassette 12, comprising a compressible retentate sheet 102, a filter sheet 104, a foraminous permeate sheet 106, a filter sheet 108, and a compressible retentate sheet 110, as constituent sheets in the multilayer array.

As shown, each of the constituent filter sheets 104, 106, and 108 has a generally quadrilateral-shaped cut-out opening 114A and 114B at one end thereof, and a similar cut out opening 112A and 112B at the opposite end thereof, and each of the sheets is provided with corner openings 16, 18, 20, 22, 64, 66, 68, and 70.

As shown, each of the compressible retentate sheets 102 and 110 has quadrilateral retentate channels 116A and 116B.

Each of sheets is generally co-extensive in areal extent with the others, and when consolidated into a unitary cassette article, the cutout openings 112A and 112B and 114A and 114B and retentate channels 116A and 116B in each of the respective sheet elements are in registration, as are the rod openings 16, 18, 20, 22, 64, 66, 68, and 70. The sheets are each bonded at their side and end extremities to the next adjacent sheet in the cassette, and the retentate sheet 102 is bonded at its peripheral region 120 to the corresponding peripheral region of filter sheet 104, and in like manner the retentate sheet 110 is bonded at its peripheral portion 122 to filter sheet 108. Permeate sheet 106 is bonded at its outer periphery 124 on its top face to filter sheet 104, and the permeate sheet at its bottom face is bonded along its peripheral region 126 to filter sheet 108.

On the retentate sheets, a longitudinally extending, transversely spaced-apart rib 128 is provided, extending from the inlet basin opening 112 and 112B to the collection basin opening 114A and 114B.

The permeate sheet 106 is suitably bonded to the adjacent filter sheets (108 and 104, respectively) in such manner as to leave an unbonded central area 130 on permeate sheet 106 which communicates with the filtrate or permeate openings 24A, B, C, D, E and 26A, B, C, D, E whereby filtrate is readily removed from the cassette in use.

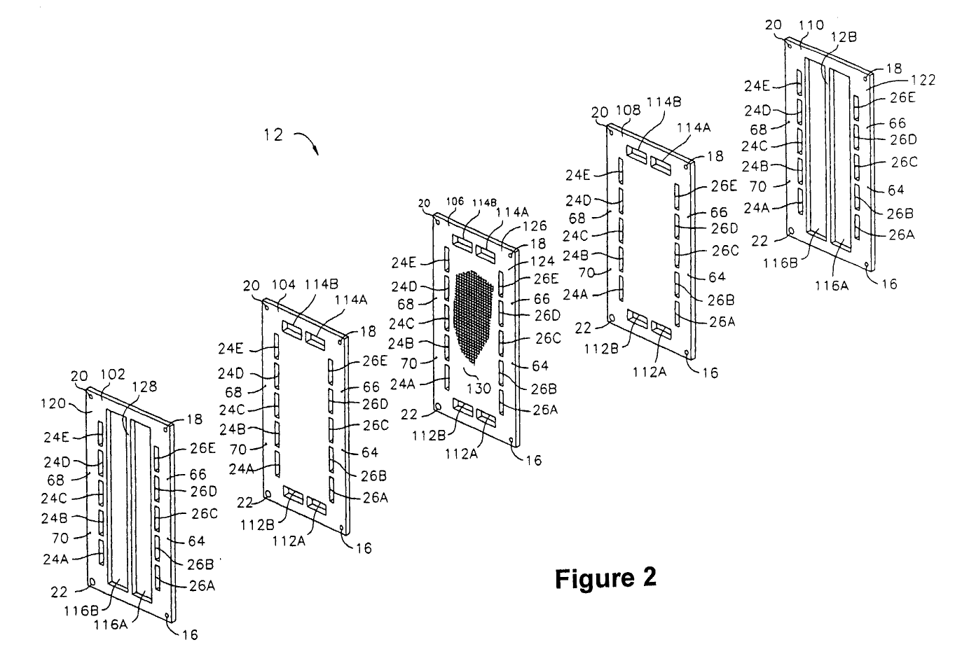

FIG. 3 is a cross-sectional view of the filtration cassette of FIG. 2, being fully encapsulated by a gasket layer 2 on all its sides, and FIG. 3A is a cross-sectional view of such filtration cassette of FIG. 2 being covered by two gasket layers 2 only on its upper and bottom surfaces.

It is understood that FIGS. 1-3A only shows generalized configurations of filtration cassette in relation to gasket layers for purpose of simple illustration. Such configurations shall not be construed in any manner as limitations against the broad scope of the present invention.

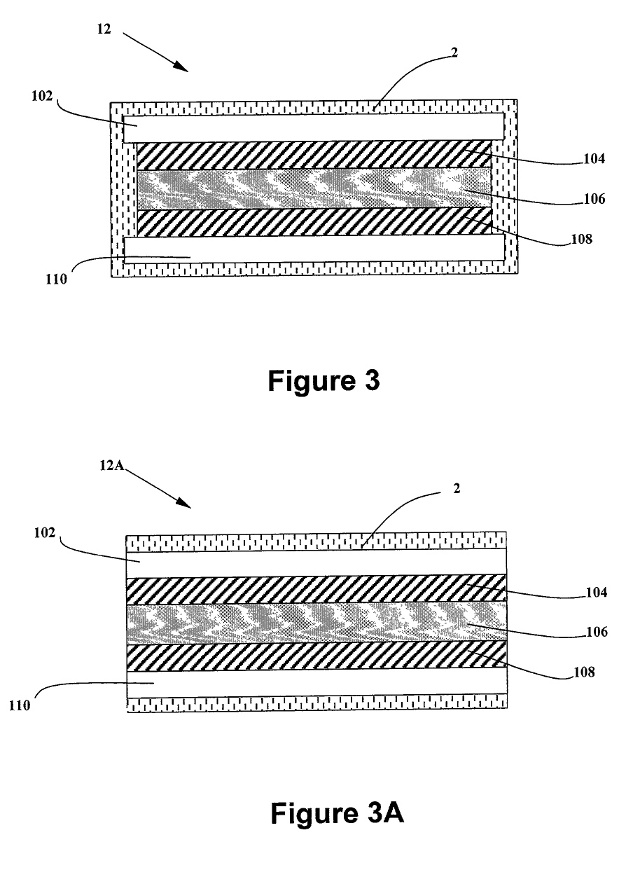

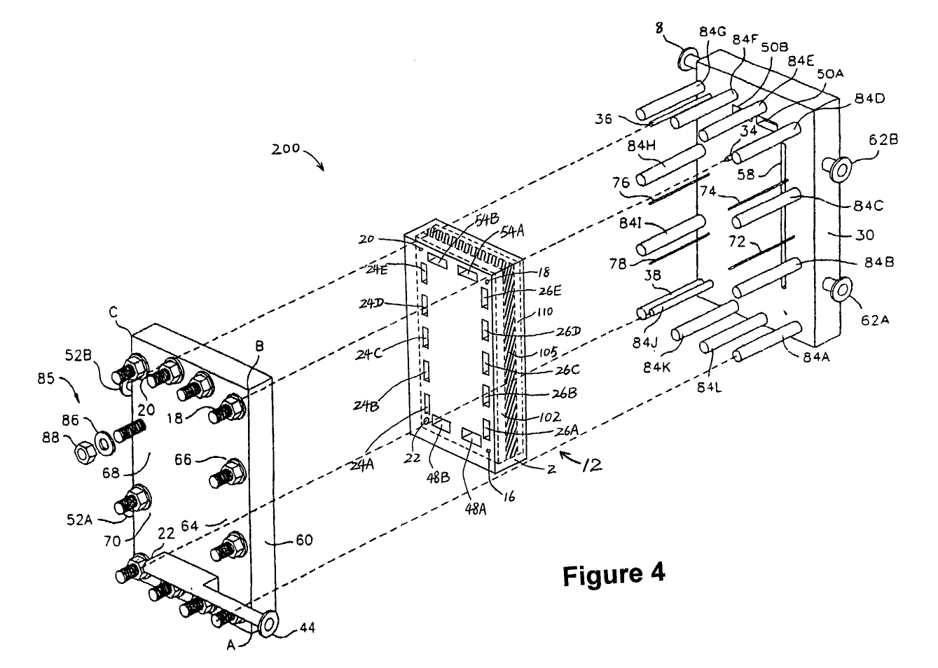

FIG. 4 is an exploded view of a cross-flow filter assembly 200 comprising the integral gasket filtration cassette structure 12 as in FIG. 3 being placed between a first end plate 30 and a second end plate 60. The first end plate 30 is generally a mounting plate having vertically upwardly extending rods 34, 36, and 38 at its respective corner portions as shown. The rods 34 and 36 are of the same diameter, wherein the rod 38 is of larger diameter to provide the plate orientation keying structure, which will ensure that the constituent plates of the filter assembly are assembled in the proper orientation, since the corresponding rod mounting openings 18 and 20 in the cassettes, e.g., cassette 12, are of the same diameter, accommodating the smaller diameter rods, while the third rod mounting opening 22 is of larger diameter, to accommodate rod 38. Thus, by providing a rod of larger diameter, and forming the cassettes 12 with correspondingly shaped openings, the proper registration of the cassette openings with the proper rods is assured, resulting in correct orientation of the respective stacked filtration cassettes in the array.

The first end plate 30 optionally has vertically upwardly extending rods 72, 74, 76, and 78 correspond to openings 64, 66, 68, and 70 in the filtration cassette.

It will be appreciated from the foregoing that any other cassette orientation registration device may be employed to ensure to correct positioning of the filtration cassette on the end plate 30. For example, the cassettes are oriented with their successive notches superposed with respect to one another. Alternatively, the cassette itself may be embossed, etched, or otherwise manufactured with an orientational device, e.g., a raised protrusion in the shape of an arrow, to indicate the correct orientation of the filtration cassette when stacked on the end plate 30. Although only one filtration cassette is illustratively shown in the FIG. 4 embodiment, it will be recognized that one or a plurality of cassettes may be employed to form a filter in accordance with the present invention.

Overlying the cassette 12 in the exploded array of FIG. 1 is a second end plate 60, which is provided with suitable openings 18, 20, 22, 64, 66, 68, and 70 accommodating the insertion therethrough of the rods 34, 36, 38, 72, 74, 76, and 78. Such second end plate 60 as shown is suitably engaged by mechanical fastener assemblies 85, comprising washer 86 and lock-nut 88, which threadably engages the complementarily threaded upper ends of the respective rods 84A . . . 84K, and 84L.

At the upper left-hand corner portion of the end plate 30 as shown in FIG. 1, adjacent to rod 36, there is provided a liquid outlet conduit 8 in flow communication with openings 50A and 50B extending through the end plate 30 and communicating with the quadrilateral-shaped collection basins 54A and 54B of the cassette.

The end plate 30 also is provided at its right-hand side margins, at the distal section of the longitudinally extending plate, with permeate collection trough 58 which is in flow communication with permeate outlet conduits 62A and 62B. This is employed for egress of permeate produced in the filtration operation (and issuing from filtrate or permeate opening 26A, B, C, D, E in cassette 12) and/or otherwise for accommodating ingress/egress of a selected fluid, such as steam or other sterilant fluid for effecting cleaning and regeneration of the filter.

At the lower right-hand corner portion of the end plate 60 shown in FIG. 1 there is provided a liquid inlet conduit 44 in flow communication with openings 46A and 46B (not shown) extending through the end plate 60 and communicating with the quadrilateral-shaped collection basins 48A and 48B of the cassette.

The end plate 60 also is provided at its left-hand side margin, at the near-section of the longitudinally extending plate, with permeate collection trough 56 (not shown) in flow communication with permeate outlet conduits 52A and 52B. This conduit is employed for egress of permeate produced in the filtration operation (and issuing from filtrate or permeate opening 24A, B, C, D, E in cassette 12), and/or otherwise for accommodating ingress/egress of a selected fluid, such as steam or other sterilant fluid for effecting cleaning and regeneration of the filter.

The cassette 12 shown in FIG. 4 has a quadrilateral-shaped feed distribution trough, in which liquid entering in feed liquid conduit 44 issues from feed liquid openings 46A and 46B (not shown) therein and is distributed in the feed distribution basin 48A and 48B, from which it passes longitudinally through the cassette 12, in a flow channel provided between the retentate sheet and adjacent filter sheets, as hereinafter more fully described. In the flow channel, the permeate components of the feed material passes through the filter sheets adjacent to the retentate sheet, and flows into next-adjacent permeate channels, from which the permeate flows to openings 24A, B, C, D, E and 26A, B, C, D, E. The retentate then issues from an opposite end portion of the central flow channel of the cassette into the collection basins 54A and 54B, from which the retentate is discharged from the filter through openings 50A and 50B into liquid conduit 8.

It will be appreciated that the permeate openings 24A, B, C, D, E and 26A, B, C, D, E may, as previously described, be coupled to a flow circuit including a second mass transfer medium which is to be passed in mass transfer relationship to the primary feed material stream entering the filter in conduit 44. By such arrangement, mass transfer can be carried out in both directions across the filter sheets in the cassette. Alternatively, the filter may be used as shown, with the openings 24A, B, C, D, E and 26A, B, C, D, E being used for discharge of permeate. It will be recognized that instead of two permeate conduits 62A and 62B on the end plate 30, and two permeate conduits 52A and 52B on the end plate 60, both permeate outlet conduits may be provided on the first end plate 30, or on the second end plate 60, or alternatively, both plates may feature any number of permeate discharge conduits secured thereto and in communication with the permeate openings of the cassette(s).

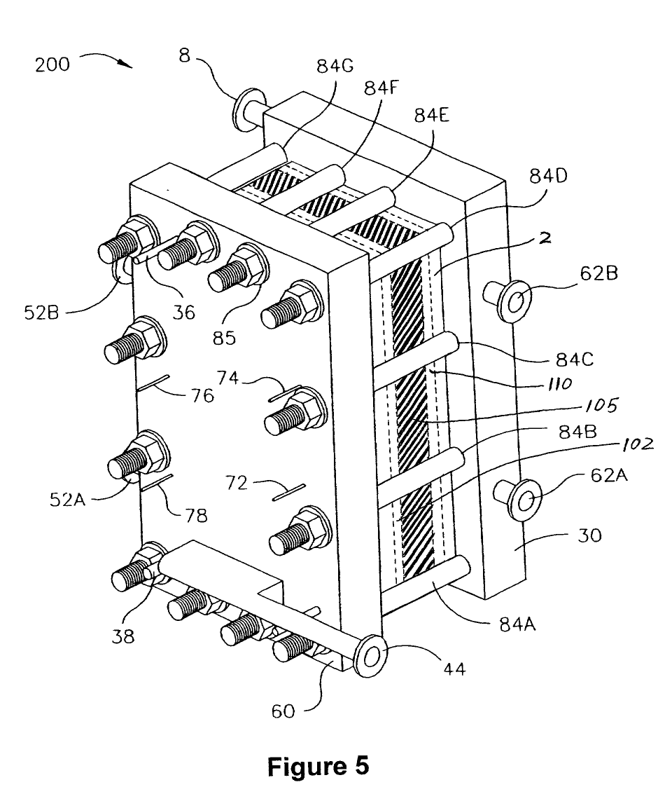

FIG. 6 is a top plan view of a portion of a filtration cassette 12, wherein the collection basin is composed of two quadrilateral shaped basins 54A and 54B.

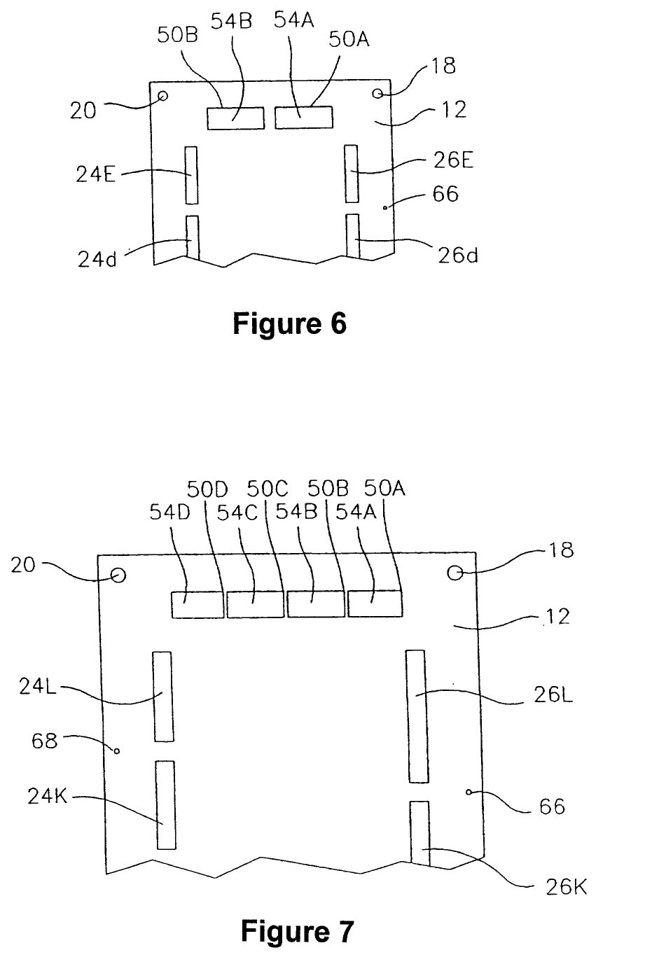

FIG. 7 is a top plan view of a cassette 12 according to another embodiment of the invention featuring four quadrilateral shaped basins 54A, 54B, 54C, and 54D. Shown in dashed line representation in the basin is the liquid collection conduit 50A, 50B, 50C, and 50D, denoting the position of the liquid withdrawal conduit relative to the basin structure. It will be recognized that the inlet distribution basins corresponding to the outlet collection basin shown in FIGS. 6 and 7, respectively, are similarly configured, with respect to their shape and component angles, relative to the same cassette article, although the distribution and collection basins could in some applications advantageously be hemispherical or of different shape and size characteristics.

Although the quadrilateral shape of the respective liquid distribution basins 48A and 48B and collection basins 54A and 54B may be widely varied in the broad practice of the present invention, as regards the specific values of the corner angles of such basins, the specific shape and angles shown in FIGS. 6 and 7 are most preferred to facilitate uniformity of flow path length for liquid across the entire areal extent of the respective basins and flow channel area, i.e., a generally uniform velocity profile of the fluid flowing longitudinally across the flow channel area of the cassette.

In the filtration cassette shown in FIG. 7, wherein the distribution basins each comprise four quadrilateral sub-basins 54A, 54B, 54C, and 54D, each sub-basin suitably comprises: side edges intersecting at a first corner defining a first included angle a therebetween of 90°; side edges intersecting at a second corner defining an included angle b therebetween of from about 90°; a third corner transversely opposite the first corner, with the side edges intersecting at the third corner defining an included angle c therebetween of 90°; and a fourth corner transversely opposite the third corner, with the side edges intersecting at the fourth comer defining an included angle d therebetween of 90°.

In like manner the distribution and collection basins could in some applications advantageously be hemispherical or of different shape and size characteristics.

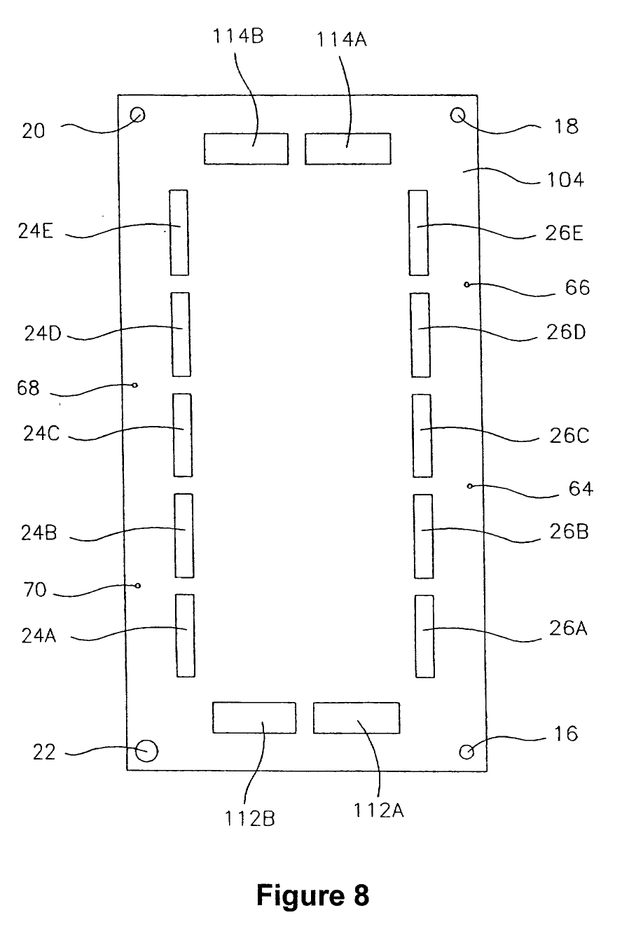

FIG. 8 is a plan view of a filter sheet of a type which may be usefully employed in the cassette of FIG. 2, and wherein all parts and elements are correspondingly numbered to FIG. 2.

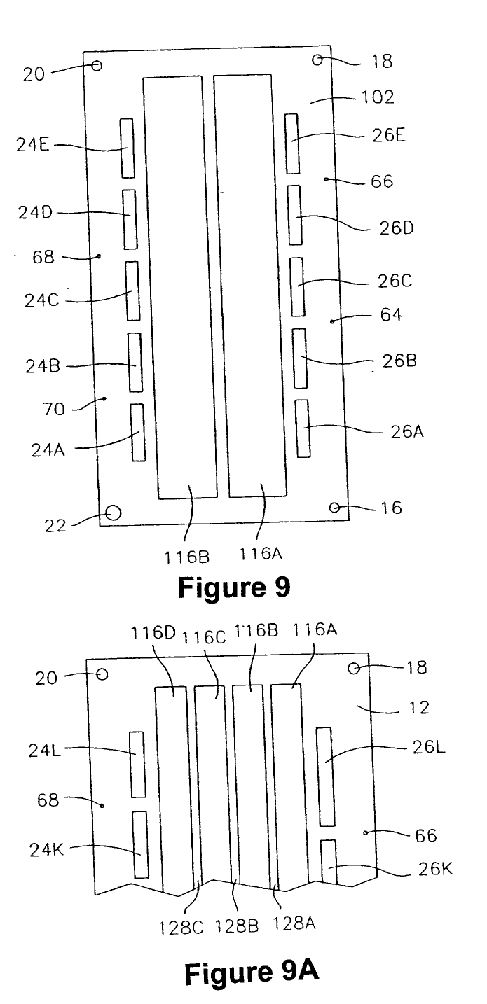

FIG. 9 is a plan view of a retentate sheet of a type which may be usefully employed in the cassette of FIG. 2, and wherein all parts and elements are correspondingly numbered to FIG. 2.

FIG. 9A is a top plan view of a portion of a retentate sheet according to another embodiment of the invention, featuring four quadrilateral-shaped basins 116A, B, C, and D, and featuring additional permeate channels 24F-L and 26F-L, beyond the corresponding two basin structure of FIG. 9, but wherein all other elements of FIG. 9A are numbered correspondingly to FIG. 9.

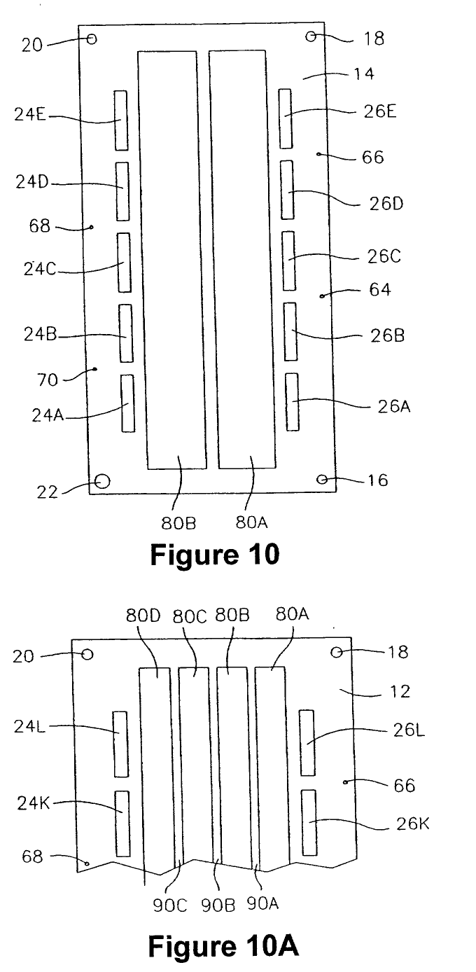

FIG. 10 is a plan view of a compressible retentive sheet of a type which may be usefully employed in the cassette of FIG. 2, featuring longitudinal retentate channels 80A and B separated by rib 90, and wherein the permeate openings and rod mounting openings are numbered correspondingly to FIG. 2.

FIG. 10A is a plan view of a compressible retentive sheet according to another embodiment of the invention, featuring four quadrilateral-shaped basins 80A-D, separated by longitudinally extending, transversely spaced-apart ribs 90A-C, and wherein the permeate openings and rod mounting openings are numbered correspondingly to FIG. 10 and FIG. 2.

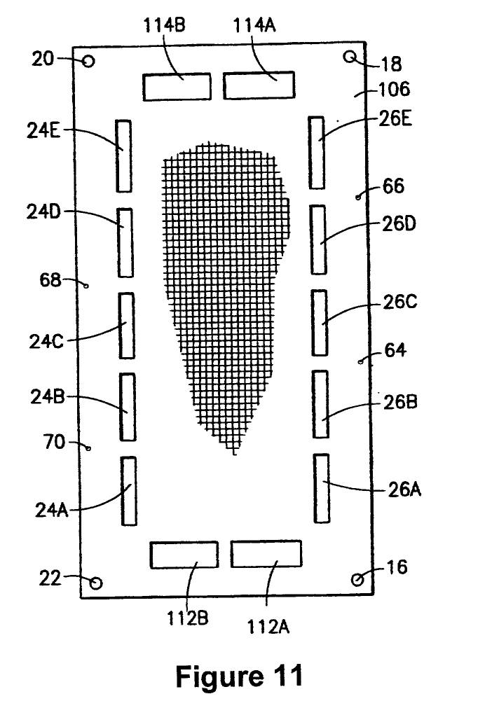

FIG. 11 is a plan view of a formaminous permeate sheet of a type which may be usefully employed in the cassette of FIG. 2, and which is numbered correspondingly to FIG. 2.

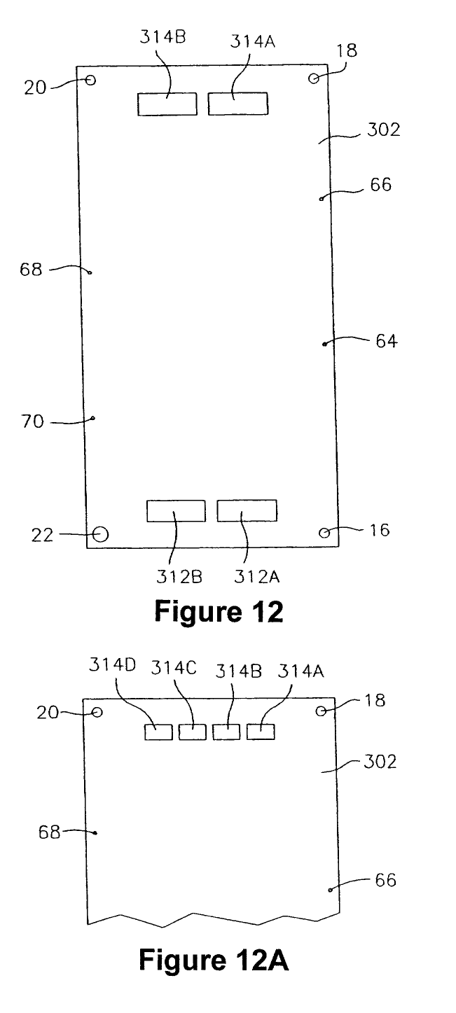

FIG. 12 is a top plan view of a portion of a cassette 302, composed of permeate sheet/filter sheet/permeate sheet members featuring two quadrilateral-shaped basins 314A, B at one end portion of the multilaminate stack, and two quadrilateral-shaped basins 312A, B at the other end portion of the multilaminate stack, after the first die cut.

FIG. 12A is a top plan view of a portion of a filtration cassette, composed of permeate sheet/filter sheet/permeate sheet members according to another embodiment of the invention, featuring four quadrilateral-shaped basins 314A-D, after the first die cut.

The features and advantages of the invention are more fully shown with respect to the following illustrative example.

### EXAMPLE

Fifteen grams of Part A silicone (MED-6010 Part A produced by NuSil Technology, Carpinteria, Calif.) and fifteen grams of Part B silicone (MED-6010 Part B produced by NuSil Technology) were mixed with 10 mL of chloroform. The mixture was rotated/mixed for 30 minutes to form a silicone-containing paste.

Such silicone-containing paste was then degassed at room temperature in a Fisher® vacuum oven. A vacuum pressure of about 762 mm Hg was maintained for 30 minutes, until all visible air bubbles was removed thereby. Please note that the time for degassing is depending on the amount of the silicone-containing pasted so processed and the capacity of the vacuum oven employed.

A thin layer of such mixture was subsequently applied onto the outer surface of a filter cassette as described hereinabove. The filtration cassette with such thin layer of silicone-containing mixture applied thereon was dried in a fume hood overnight, while the chloroform solvent evaporated.

The dried filtration cassette was then placed in a mold at room temperature and atmosphere pressure, into which the rest of the silicone-containing mixture was slowly poured into, in a manner for minimizing generation of air bubbles during such process. Specifically, the silicone-containing paste was given sufficient time (about 6 to 10 hours) to flow into the interstitial space between the mold and the filter. Alternatively, the silicone-containing mixture may be injected into the mold or otherwise introduced to further reduce generation of air bubbles.

After molding, the mold containing both the filtration cassette and the silicone-containing paste encapsulating such filtration cassette was placed into a Fisher® oven for curing. The curing process was conducted at a constant temperature of about 70° C. for a duration of at least 12 hours. Alternatively, such curing process can be conducted at higher temperatures (such as about 150° C.) for a shorter duration (about three hours or less). The curing can be also be performed at higher pressure in a press cure apparatus to further shorten the curing time required.

While the invention has been described herein with respect to various illustrative aspects, features and embodiments, it will be recognized that the invention is not thus limited, but that the present invention extends to and encompasses other features, modifications, and alternative embodiments, as will readily suggest themselves to those of ordinary skill in the art based on the disclosure and illustrative teachings herein. The claims that follow are therefore to be construed and interpreted as including all such features, modifications and alternative embodiments, within their spirit and scope.

1.An integral gasketed filtration cassette structure comprising:
(a) a filtration cassette comprising a multilaminate array of sheet members of generally rectangular and generally planar shape with main top and bottom surfaces, wherein the sheet members include in sequence in the array a terminal end plate, a first retentate sheet, a first filter sheet, a permeate sheet, a second filter sheet, and a second retentate sheet, and a second terminal end plate, wherein each of the sheet members in the array has at least one inlet basin opening at one end thereof, and at least one outlet basin opening at an opposite end thereof, with at least one permeate passage opening;
each of the first and second retentate sheets having at least one channel opening therein, wherein each channel opening extends longitudinally between the inlet and outlet basin openings of the sheets in the array and is open through the entire thickness of the retentate sheet, and with each of the first and second retentate sheets being bonded to an adjacent filter sheet about peripheral end and side portions thereof, with their basin openings and permeate passage openings in register with one another, and arranged to permit flow of filtrate through the channel openings of the retentate sheet between the inlet and outlet basin openings to permit permeate flow through the filter sheet to the permeate sheet to the permeate passage openings;
wherein each of the filter sheets is secured at its peripheral portions on a face thereof opposite the retentate sheet, to the permeate sheet;
(b) at least one thin gasket layer bonded to a surface of said filtration cassette and forming an integral unitary structure with said filtration cassette, wherein said thin gasket layer comprises an elastomeric material for forming a fluid-tight seal between the filtration cassette and an adjacent structure when engaged therewith.

2. The integral filtration cassette structure of claim 1, wherein the thin gasket layer comprises an elastomeric material having a hardness in the range from about 30 to about 80 durometers.

3. The integral filtration cassette structure of claim 1, wherein the thin gasket layer comprises an elastomeric material having a hardness in the range from about 40 to about 60 durometers.

4. The integral filtration cassette structure of claim 1, wherein the thin gasket layer has a thickness in the range from about 0.01 inch to about 0.1 inch.

5. The integral filtration cassette structure of claim 1, wherein the thin gasket layer has a thickness in the range from about 0.02 inch to about 0.06 inch.

6. The integral filtration cassette structure of claim 1, wherein the thin gasket layer has a temperature resistance at east within the temperature range from about 0° C. to about 70° C.

7. The integral filtration cassette structure of claim 1, wherein the thin gasket layer has a temperature resistance within the temperature range from about −10° C. to about 150° C.

8. The integral filtration cassette structure of claim 1, wherein the thin gasket layer fully encapsulates said filtration cassette.

9. The integral filtration cassette structure of claim 1, wherein the thin gasket layer partially covers the surface of said filtration cassette.

10. The integral filtration cassette structure of claim 1, wherein the thin gasket layer comprises a material selected from the group consisting of silicone, ethylenepropylenedienemonomer (EPDM), viton, polyurethane, polypropylene, polyethylene, polyvinylchloride, polyester, epoxy, ethylvinylacetate, bunnas, and styrene butadiene.

11. The integral filtration cassette structure of claim 1, wherein the thin gasket layer comprises silicone.

12. The integral filtration cassette structure of claim 1, wherein the thin gasket layer is securely bonded onto the surface of said filtration cassette by a method selected from the group consisting of molding, adhering, welding, and spray coating.

13. The integral filtration cassette structure of claim 1, wherein the thin gasket layer is molded onto the surface of said filtration cassette.

14. The integral filtration cassette structure of claim 1, wherein the thin gasket layer is adhered onto the surface of said filtration cassette.

15. The integral filtration cassette structure of claim 1, wherein the securely bonded onto the surface of the said filtration cassette by radio-frequency welding, ultra sonic welding, or heat welding.

16. The integral filtration cassette structure of claim 1, further comprising a feed material inlet port communicating with said at least one inlet basin opening, and a retentate outlet port communicating with said at least one outlet basin opening, wherein the inlet and outlet ports are diagonally opposite one another on said cassette.

17. A stacked cassette filter including a stacked assembly of integral gasketed filtration cassette structures, each comprising:
(a) a filtration cassette comprising a multilaminate array of sheet members of generally rectangular and generally planar shape with main top and bottom surfaces, wherein the sheet members include in sequence in the array a first retentate sheet, a first filter sheet, a permeate sheet, a second filter sheet, and a second retentate sheet, wherein each of the sheet members in the array has at least one inlet basin opening at one end thereof, and at least one outlet basin opening at an opposite end thereof, with at least one permeate passage opening:
each of the first and second retentate sheets having at least one channel opening therein, wherein each channel opening extends longitudinally between the inlet and outlet basin openings of the sheets in the array and is open through the entire thickness of the retentate sheet, and with each of the first and second retentate sheets being bonded to an adjacent filter sheet about peripheral end and side portions thereof, with their basin openings and permeate passage openings in register with one another, and arranged to permit flow of filtrate through the channel openings of the retentate sheet between the inlet and outlet basin openings to permit permeate flow through the filter sheet to the permeate sheet to the permeate passage openings;
wherein each of the filter sheets is secured at its peripheral portions on a face thereof opposite the retentate sheet, to the permeate sheet;
(b) at least one thin gasket layer bonded onto a surface of said filtration cassette and forming an integral unitary structure with said filtration cassette, wherein said thin gasket layer comprises an elastomeric material for forming a fluid-tight seal between the filtration cassette and an adjacent structure when engaged therewith.

18. A filter assembly comprising:
(a) a first end plate;
(b) a second end plate;
(c) one or more integral filtration cassette structures as of claim 1 secured between the first and the second end plate, wherein the thin gasket layers of said integral filtration cassette structures form fluid-tight sealing surfaces between said filtration cassettes and said first and second end plates as well as between adjacent filtration cassette structures.
